(19) United States
(12) Patent Application Publication
(10) Pub. No.: US 2018/0192041 A1
(43) Pub. Date: Jul. 5, 2018

(54) TIMING CORRECTION METHOD AND MODULE FOR 3D DISPLAY, AND 3D DISPLAY SYSTEM USING THE SAME

(71) Applicant: Isuncloud Limited, Hong Kong (HK)

(72) Inventors: Ping Chen, Hong Kong (HK); Jun Ma, Hong Kong (HK)

(21) Appl. No.: 15/398,028

(22) Filed: Jan. 4, 2017

(51) Int. Cl. H04N 13/04; G09G 3/00

(52) U.S. Cl. CPC H04N 13/0438; H04N 13/044; H04N 13/0497; H04N 2213/001; G09G 3/003; H04N 2213/008; H04N 13/0422

(57) ABSTRACT

This disclosure provides a timing correction method for 3D display and system. The method includes the following steps: transmitting correction video stream having a preset frame rate to display device, where two successive frame of images of the correction video stream are a first image and a second image respectively; obtaining display image corresponding to the correction video stream, and recording a first time point at which a preset image has been acquired; determining a time difference between the first time point which the preset image has been acquired and a second time point which the preset image has been sent out; correcting, according to the time difference, a time point which a switch signal is transmitted from the master control system to the 3D glasses. This disclosure enables optimal synchronization between a shutter control of the 3D glasses and the timing of the display device, thereby improving user experience.

### TECHNICAL FIELD

This disclosure relates to communication field, and in particular to a timing correction method and module for three-dimensional (3D) display, and a 3D display system using the same.

### BACKGROUND

With development of 3D technology, 3D display systems have been used more and more.

Nowadays, there is time error between a conventional 3D display device and shutter control of 3D glasses. This may lead to imperfect synchronization between the shutter control of the 3D glasses and a display image, thereby causing bad user experience.

Therefore, the 3D display system needs to be improved to overcome the existing drawbacks.

### SUMMARY OF THIS DISCLOSURE

Various embodiments of this disclosure provide a timing correction method and module for 3D display, and a 3D display system, so as to solve the above-described problems.

In an embodiment of this disclosure, a timing correction method for 3D display is provided, where a 3D display system includes 3D glasses, a master control system and a display device. The timing correction method includes the following steps:

transmitting a correction video stream having a preset frame rate to the display device for display, where two successive frame of images of the correction video stream are a first image and a second image respectively;

obtaining a display image corresponding to the correction video stream, and recording a first time point at which a preset image has been acquired;

determining a time difference between the first time point at which the preset image has been acquired and a second time point at which the preset image has been sent out;

correcting, according to the time difference, a time point at which a switch signal is transmitted from the master control system to the 3D glasses.

Preferably, the first image is a completely white image, and the second image is a completely black image.

Preferably, the preset image is the first completely white image or the first completely black image of the correction video stream.

This disclosure also provides a timing correction module for 3D display, where the timing correction module includes an image acquisition apparatus and a correction apparatus that are in communication with each other.

The correction apparatus includes:

a transmitting module for transmitting a correction video stream having a preset frame rate to a display device for display, where two successive frame of images of the correction video stream are a first image and a second image respectively;

an obtaining module for obtaining a display image corresponding to the correction video stream and a first time point at which a preset image has been acquired;

a calculation module for determining a time difference between the first time point at which the preset image has been acquired and a second time point at which the preset image has been sent out;

a correction module for correcting, according to the time difference, a time point at which a switch signal is transmitted from a master control system to 3D glasses;

the image acquisition apparatus is used for acquiring the display image corresponding to the correction video stream, recording the first time point at which the preset image has been acquired, and transmitting the acquired display image and the first time point to the obtaining module of the correction apparatus.

Preferably, the first image is a completely white image, and the second image is a completely black image.

Preferably, the preset image is the first completely white image or the first completely black image of the correction video stream.

Preferably, the image acquisition apparatus is a cell phone or a PAD equipped with a camera.

This disclosure also provides a 3D display system, which includes any one of the above-described timing correction module for 3D display, a 3D display device, a master control system and 3D glasses. The master control system is in communication with the 3D display device and the 3D glasses respectively, and the timing correction module is in communication with the master control system.

Preferably, the master control system includes an HDMI input interface and an HDMI output interface, and the 3D display device includes an HDMI input interface.

This disclosure also provides a 3D display system, which includes any one of the above-described timing correction module for 3D display, a 3D display device, a master control system and 3D glasses. The master control system is in communication with the 3D display device and the 3D glasses respectively, and the timing correction module is in communication with the master control system.

The 3D glasses include an eyeglass assembly and a control component that are separated from each other. The eyeglass assembly includes a frame and lenses. The lenses are provided with a liquid crystal light valve layer. The frame is provided with a driving circuit that is electrically connected with the liquid crystal light valve layer and a first electric connector that is electrically connected with the driving circuit, where the driving circuit is used for driving the liquid crystal light valve layer to be switched on or off.

The control component includes a wireless communication module, a control module, a second electric connector and a power supply module. The wireless communication module, the control module and the second electric connector are successively connected with each other, and the power supply module are electrically connected with the second electric connector and the control module respectively. The second electric connector and the first electric connector can have detachable plug connection.

The wireless communication module is used for receiving a trigger signal from an external 3D display system, and the control module is used for generating a first control signal according to the trigger signal. When the second electric connector and the first electric connector are plugged together, the liquid crystal driving circuit is powered by the power supply module through the first and second electric connectors, and the first control signal is transmitted by the control module to the driving circuit through the first and second electric connectors so that the driving circuit controls the liquid crystal light valve layer to be switched on or off.

A piezoelectric coating that is electrically connected with the driving circuit is further provided within the lenses. The control module is further used for controlling the driving circuit to drive the piezoelectric coating to change a shape of the lenses.

The frame is made of insulating medium. The first electric connector includes a first printed circuit layer arranged on the frame, and a first plug connector detachably arranged on (e.g., sleeved onto) the frame, where the first plug connector and the first printed circuit layer are electrically connected with each other.

The driving circuit includes multiple electronic components mounted on the frame and a second printed circuit layer for connecting the multiple electronic components.

The control component further includes a wearable accessory, and the wireless communication module, the control module, the second electric connector and the power supply module are all arranged on the wearable accessory.

The wearable accessory is made of insulating medium. The second electric connector includes a third printed circuit layer arranged on a surface of the wearable accessory, and a second plug connector arranged on the wearable accessory. The second plug connector is electrically connected with the control module through the third printed circuit layer, and the power supply module is electrically connected with the second plug connector through the third printed circuit layer, where the second plug connector can have detachable plug and electrical connection with the first plug connector.

Compared with the prior art, this disclosure corrects the time point at which the switch signal is transmitted from the master control system to the 3D glasses, such that a conventional display device can be converted to have the 3D display function, and a shutter control of the 3D glasses can be perfectly synchronized with the timing of the display device, thereby improving the user experience.

### BRIEF DESCRIPTION OF THE DRAWINGS

FIG. 1 is a structural diagram for a 3D glasses system in a preferred embodiment of this disclosure.

FIG. 2 is a structural diagram for an eyeglass assembly of the 3D glasses system in the embodiment shown in FIG. 1 of this disclosure.

FIG. 3 is a schematic diagram for a 3D display system in an embodiment of this disclosure.

### DETAILED DESCRIPTION

For the reference signs, the same component reference signs refer to the same components. This disclosure is described according to its implementation in a suitable computing environment as an example. Following descriptions are based on specific embodiments of this disclosure, while those descriptions should not be deemed as limitations to some other embodiments of this disclosure that are not described in detail here.

Unless otherwise specified, specific embodiments of this disclosure, among the following descriptions, will be described with reference to steps and signs that are executed by one or more computers. Therefore, it can be understood that those steps and operations may be referred to be performed by computers several times, where the operations may include those operated by a computer processing unit using electronic signals, such as structural data. Those operations may achieve data conversion, or maintain the data within an internal storage of the computer. Also, the computer operations may be reconfigured or otherwise changed using some methods well-known to the person skilled in the art. The maintained data structure refers to a physical location of the internal storage, which haves a particular characteristic defined by the data format. However, those literal descriptions are used to explain this disclosure, rather than limitation. The person skilled in the art can also understand that, the following steps and operation can be realized in hardware.

### First Embodiment

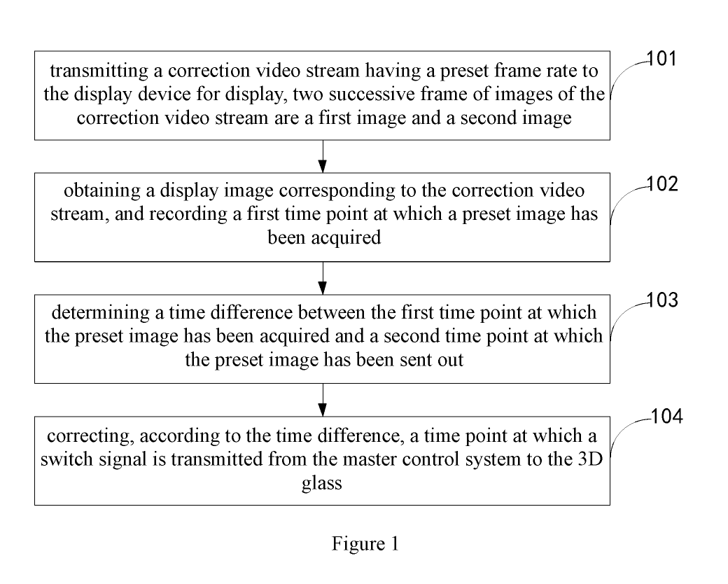

Please referring to FIG. 1, this disclosure provides a timing correction method for 3D display. A 3D display system includes 3D glasses, a master control system and a display device. The timing correction method includes the following steps:

S101, transmitting a correction video stream having a preset frame rate to the display device for display, where two successive frame of images of the correction video stream are a first image and a second image respectively;

S102, obtaining a display image corresponding to the correction video stream, and recording a first time point at which a preset image has been acquired;

S103, determining a time difference between the first time point at which the preset image has been acquired and a second time point at which the preset image has been sent out;

S104, correcting, according to the time difference, a time point at which a switch signal is transmitted from the master control system to the 3D glasses.

Here, the first image is a completely white image, and the second image is a completely black image. The preset image is the first completely white image or the first completely black image of the correction video stream.

It can be seen that, this disclosure corrects the time point at which the switch signal is transmitted from the master control system to the 3D glasses, such that a conventional display device can be converted to have the 3D display function, and a shutter control of the 3D glasses can be perfectly synchronized with the timing of the display device, thereby improving the user experience.

### Second Embodiment

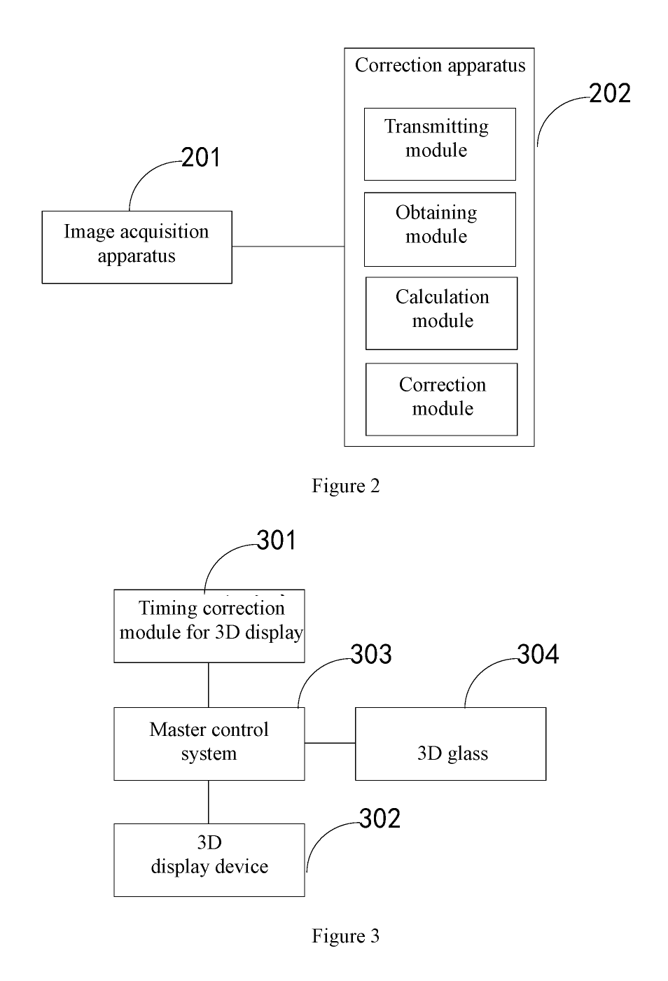

As shown in FIG. 2, this disclosure also provides a timing correction module for 3D display, where the timing correction module includes an image acquisition apparatus 201 and a correction apparatus 202 that are in communication with each other. The correction apparatus 202 can perform the respective steps of the timing correction method for 3D display in the first embodiment.

Specifically, the correction apparatus 202 includes:

a transmitting module for transmitting a correction video stream having a preset frame rate to a display device for display, where two successive frame of images of the correction video stream are a first image and a second image respectively;

an obtaining module for obtaining a display image corresponding to the correction video stream and a first time point at which a preset image has been acquired;

a calculation module for determining a time difference between the first time point at which the preset image has been acquired and a second time point at which the preset image has been sent out;

a correction module for correcting, according to the time difference, a time point at which a switch signal is transmitted from a master control system to 3D glasses;

the image acquisition apparatus is used for acquiring the display image corresponding to the correction video stream, recording the first time point at which the preset image has been acquired, and transmitting the acquired display image and the first time point to the obtaining module of the correction apparatus.

Specifically, the first image is a completely white image, and the second image is a completely black image. The preset image is the first completely white image or the first completely black image of the correction video stream. The image acquisition apparatus 201 is a cell phone or a PAD equipped with a camera.

It can be seen that, this disclosure corrects the time point at which the switch signal is transmitted from the master control system to the 3D glasses, such that a conventional display device can be converted to have the 3D display function, and a shutter control of the 3D glasses can be perfectly synchronized with the timing of the display device, thereby improving the user experience.

### Third Embodiment

This disclosure also provides a 3D display system, which includes the timing correction module for 3D display 301 in the above-described embodiments, a 3D display device 302, a master control system 303 and 3D glasses 304. The master control system is in communication with the 3D display device and the 3D glasses 304 respectively, and the timing correction module is in communication with the master control system.

The master control system 303 includes an HDMI input interface and an HDMI output interface, and the 3D display device 302 includes an HDMI input interface.

The 3D glasses 304 include an eyeglass assembly and a control component that are separated from each other. The eyeglass assembly includes a frame and lenses. The lenses are provided with a liquid crystal light valve layer. The frame is provided with a driving circuit that is electrically connected with the liquid crystal light valve layer and a first electric connector that is electrically connected with the driving circuit, where the driving circuit is used for driving the liquid crystal light valve layer to be switched on or off.

The control component includes a wireless communication module, a control module, a second electric connector and a power supply module. The wireless communication module, the control module and the second electric connector are successively connected with each other, and the power supply module are electrically connected with the second electric connector and the control module respectively. The second electric connector and the first electric connector can have detachable plug connection.

The wireless communication module is used for receiving a trigger signal from an external 3D display system, and the control module is used for generating a first control signal according to the trigger signal. When the second electric connector and the first electric connector are plugged together, the liquid crystal driving circuit is powered by the power supply module through the first and second electric connectors, and the first control signal is transmitted by the control module to the driving circuit through the first and second electric connectors so that the driving circuit controls the liquid crystal light valve layer to be switched on or off.

A piezoelectric coating that is electrically connected with the driving circuit is further provided within the lenses. The control module is further used for controlling the driving circuit to drive the piezoelectric coating to change a shape of the lenses.

The frame is made of insulating medium. The first electric connector includes a first printed circuit layer arranged on the frame, and a first plug connector detachably arranged on (e.g., sleeved onto) the frame, where the first plug connector and the first printed circuit layer are electrically connected with each other.

The driving circuit includes multiple electronic components mounted on the frame and a second printed circuit layer for connecting the multiple electronic components.

The control component further includes a wearable accessory, and the wireless communication module, the control module, the second electric connector and the power supply module are all arranged on the wearable accessory.

The wearable accessory is made of insulating medium. The second electric connector includes a third printed circuit layer arranged on a surface of the wearable accessory, and a second plug connector arranged on the wearable accessory. The second plug connector is electrically connected with the control module through the third printed circuit layer, and the power supply module is electrically connected with the second plug connector through the third printed circuit layer, where the second plug connector can have detachable plug and electrical connection with the first plug connector.

Various operations of embodiments are provided herein. In one embodiment, one or more operations may constitute computer readable instructions stored on one or more computer readable mediums, which cause the computing device to execute the operations when being executed by an electronic device. Although some or all operations are described in sequence, those sequences should not be interpreted as the necessary sequences for those operations. The person skilled in the art can understand alternative sequences having the beneficial of this disclosure. Also, it should be understood that not all operations have to exist in each embodiment of this disclosure.

Moreover, the term “preferred” used herein refers to example(s) or example illustration(s). Any aspects or designs that are described to be “preferred” are not required to be interpreted as being better than other aspects or designs. In contrary, the term “preferred” is used to propose solution concept through specific implementation. The terminology “or” used herein means inclusive rather than exclusive. That is, unless otherwise specified or clarified in the context, “X uses A or B” means to include any one of the listing objects. That is, if X uses A, X uses B, or, X uses both A and B, the terminology “X uses A or B” is achieved in any one of the aforementioned examples.

Also, although this disclosure is described with reference to one or more implementations, the person skilled in the art can come up with equivalent modifications and amendments based on reading and understanding of the specifications and figures. This disclosure can cover all these amendments and modifications, and its scope is only defined by the appended claims. In particular, for various functions of the above-described components (such as components, resources, etc.), those terminologies for describing these components are aimed at corresponding to any component (unless otherwise specified) that achieves the specified functions of the component (e.g., having equivalent function), no matter its structure is same as or different from that for achieving the function in the exemplary embodiment of this disclosure. In addition, although specific features of this disclosure have been disclosed through one of several implementations, these features can be combined with one or more other features in other implementations, where the one or more features are desired and advantageous for a given or a specific application. For the terminologies “include”, “have”, “contain”, or other modifications used in specific implementations or claims, they are the same as the terminology “comprise” to mean to be inclusive.

Various functional units in embodiments of this disclosure can be integrated within one processing module, or respective units are separated physically, or two or more units are integrated within one module. The integrated module can be implemented by hardware or software function module. When the integrated module is implemented by software function module and sold or used as an independent product, it can be stored on a computer readable storage medium. The storage medium mentioned above can be a read-only memory, a magnetic disk or an optical disk. The above-described apparatus or system can execute corresponding methods in the method embodiment.

Although this disclosure is disclosed above using preferred embodiments, the above-described preferred embodiments are not to limit this disclosure. Without departing from spirit and scope of this disclosure, the ordinary skilled person in the art can make various amendments and modifications. Therefore, the scope of protection of this disclosure is defined by claims.

1. A timing correction method for 3D display, a 3D display system comprising 3D glasses, a master control system and a display device; wherein the method comprises following steps:
transmitting a correction video stream having a preset frame rate to the display device for display, wherein two successive frame of images of the correction video stream are a first image and a second image respectively;
obtaining a display image corresponding to the correction video stream, and recording a first time point at which a preset image has been acquired;
determining a time difference between the first time point at which the preset image has been acquired and a second time point at which the preset image has been sent out;
correcting, according to the time difference, a time point at which a switch signal is transmitted from the master control system to the 3D glasses.

2. The timing correction method for 3D display of claim 1, wherein the first image is a completely white image, and the second image is a completely black image.

3. The timing correction method for 3D display of claim 2, wherein the preset image is the first completely white image or the first completely black image of the correction video stream.

4. A timing correction module for 3D display, comprising an image acquisition apparatus and a correction apparatus that are in communication with each other;
the correction apparatus comprises:
a transmitting module for transmitting a correction video stream having a preset frame rate to a display device for display, wherein two successive frame of images of the correction video stream are a first image and a second image respectively;
an obtaining module for obtaining a display image corresponding to the correction video stream and a first time point at which a preset image has been acquired;
a calculation module for determining a time difference between the first time point at which the preset image has been acquired and a second time point at which the preset image has been sent out;
a correction module for correcting, according to the time difference, a time point at which a switch signal is transmitted from the master control system to the 3D glasses;
the image acquisition apparatus is used for acquiring the display image corresponding to the correction video stream, recording the first time point at which the preset image has been acquired, and transmitting the acquired display image and the first time point to the obtaining module of the correction apparatus.

5. The timing correction module for 3D display of claim 4, wherein the first image is a completely white image, and the second image is a completely black image.

6. The timing correction module for 3D display of claim 5, wherein the preset image is the first completely white image or the first completely black image of the correction video stream.

7. The timing correction module for 3D display of claim 5, wherein the image acquisition apparatus is a cell phone or a PAD equipped with a camera.

8. A 3D display system, comprising the timing correction module for 3D display of any one of claims 4-7, a 3D display device, a master control system and 3D glasses; the master control system is in communication with the 3D display device and the 3D glasses respectively, and the timing correction module is in communication with the master control system.

9. The 3D display system of claim 8, wherein the master control system comprises an HDMI input interface and an HDMI output interface, and the 3D display device comprises an HDMI input interface.

10. A 3D display system, comprising the timing correction module for 3D display of any one of claims 4-7, a 3D display device, a master control system and 3D glasses; the master control system is in communication with the 3D display device and the 3D glasses respectively, and the timing correction module is in communication with the master control system;
the 3D glasses comprises an eyeglass assembly and a control component that are separated from each other; the eyeglass assembly comprises a frame and lenses; the lenses are provided with a liquid crystal light valve layer; the frame is provided with a driving circuit that is electrically connected with the liquid crystal light valve layer and a first electric connector that is electrically connected with the driving circuit, wherein the driving circuit is used for driving the liquid crystal light valve layer to be switched on or off;
the control component comprises a wireless communication module, a control module, a second electric connector and a power supply module; the wireless communication module, the control module and the second electric connector are successively connected with each other, and the power supply module are electrically connected with the second electric connector and the control module respectively; the second electric connector and the first electric connector can have detachable plug connection;
the wireless communication module is used for receiving a trigger signal from an external 3D display system, and the control module is used for generating a first control signal according to the trigger signal; when the second electric connector and the first electric connector are plugged together, the liquid crystal driving circuit is powered by the power supply module through the first and second electric connectors, and the first control signal is transmitted by the control module to the driving circuit through the first and second electric connectors so that the driving circuit controls the liquid crystal light valve layer to be switched on or off;
the lenses are further provided with a piezoelectric coating that is electrically connected with the driving circuit; the control module is further used for controlling the driving circuit to drive the piezoelectric coating to change a shape of the lenses;
the frame is made of insulating medium; the first electric connector comprises a first printed circuit layer arranged on the frame, and a first plug connector detachably arranged on the frame, wherein the first plug connector and the first printed circuit layer are electrically connected with each other;
the driving circuit comprises multiple electronic components mounted on the frame and a second printed circuit layer for connecting the multiple electronic components;
the control component further comprises a wearable accessory, and the wireless communication module, the control module, the second electric connector and the power supply module are all arranged on the wearable accessory;
the wearable accessory is made of insulating medium; the second electric connector comprises a third printed circuit layer arranged on a surface of the wearable accessory, and a second plug connector arranged on the wearable accessory; the second plug connector is electrically connected with the control module through the third printed circuit layer, and the power supply module is electrically connected with the second plug connector through the third printed circuit layer, wherein the second plug connector is used for detachable plug and electrical connection with the first plug connector.
